(19) United States
(12) Patent Application Publication
(10) Pub. No.: US 2005/0021457 A1
(43) Pub. Date: Jan. 27, 2005

(54) Financial account up-front incentives management system and method

(76) Inventors: A. Wayne Johnson, Atlanta, GA (US); Robert Riddett, Lawrenceville, GA (US)

Correspondence Address: REINHART BOERNER VAN DEUREN S.C.;ATTN: LINDA GABRIEL, DOCKET COORDINATOR, 1000 NORTH WATER STREET, SUITE 2100, MILWAUKEE, WI, 53202, US

(21) Appl. No.: 10/891,410

(22) Filed: Jul. 14, 2004

Related U.S. Application Data
(60) Provisional application No. 60/490,123, filed on Jul. 25, 2003.

(51) Int. Cl. G06F 17/60; G06K 19/06

(52) U.S. Cl. 705/39; 705/14

(57) ABSTRACT

A system and method for incentivizing holders of financial accounts, e.g., credit card account holders, to engage in certain activities with those accounts. Account holders may be provided an up-front incentive based on a commitment to engage in certain account activities in the future. If the account holder fails to satisfy his commitment, at least a portion of the value of the incentive may be charged to a customer account. Rewards provided to an account holder to encourage particular account activities also may include merchandise rewards, discounts and rebates or entries into a lottery type drawing for prizes.

### FIELD OF THE INVENTION

This application claims the benefit of U.S. Provisional Application No. 60/490,123, filed on Jul. 25, 2003.

The present invention pertains generally to financial accounts, such as credit card accounts, and to computer based systems and methods for managing automatically such accounts, and more particularly to systems and methods for encouraging specific account activities with respect to such accounts by holders thereof and systems and methods for managing the same.

### BACKGROUND OF THE INVENTION

Banks and other financial institutions, referred to generically herein as financial institutions, make available to their individual, commercial, and institutional customers a variety of different types of financial accounts. Such accounts range, for example, from basic checking and savings accounts to credit card accounts, retirement accounts, brokerage accounts, etc. These varieties of financial accounts allow customers of financial institutions great flexibility in the ways that they may save, spend, and invest their money. A single customer may hold various different accounts with a single financial institution. Such different accounts may be integrated in a variety of ways. For example, a customer's savings account may be tied to his checking account such that any overdraft of the checking account is automatically made good from funds on deposit in the savings account. By integrating accounts in various ways, financial institution customers are provided with even greater flexibility.

Computer systems currently are employed to manage and maintain the wide variety of financial accounts provided by financial institutions to their customers. Account management computer programs implemented on computer systems perform a wide variety of account management functions, such as facilitating the establishment (opening) of accounts, maintaining general account records and balances, posting debits and credits to accounts, automatically transferring funds between accounts at appropriate times, automatically issuing account statements to customers (as well as to the financial institution itself), etc. Any improvement to existing financial account management systems and processes should, to the greatest extent possible, be implemented for automatic operation as part of, or as an addition to, existing computer based financial account management systems.

Financial institutions make money from the various accounts that are maintained by them for their customers in a variety of ways. For example, for deposit type accounts, the financial institution is able to loan funds on deposit with the financial institution at an interest rate higher than that paid to depositors, and thereby make a profit. Significant earnings may be made by financial institutions from interest charged on consumer credit card accounts. The interest rates that can be charged for such accounts typically are much greater than that charged for secured loans, such as home mortgage loans. Another source of revenue for financial institutions is fees that may be applied by the financial institution to various accounts. For example, consumers may be required to pay periodic fees for maintaining accounts, such as annual credit card fees. Each time a credit card is used a fee is paid by the merchant at which the credit card is used, a portion of which is returned to the financial institution issuing the credit card. Fees may be charged for account activities performed by customer account holders based on various account related conditions. For example, periodic fees charged to customers for certain deposit and checking accounts may be reduced as the balances maintained in the accounts are increased. Credit card holders may be charged fees (in addition to interest fees) for cash advances from credit card accounts. (Such transaction fees typically are not charged for standard purchase transactions made with a credit card account.) Fees also may be charged to a customer for failure to abide by the rules imposed by the financial institution for maintaining the account. For example, such fees may be imposed for exceeding the account limits (account overdrawn) or failure to make a payment or making a late payment on a credit card account, etc.

Financial institutions, therefore, desire to increase earnings both by encouraging potential customers to open and use accounts with a particular financial institution, rather than with a competing financial institution, and, after an account has been established, by encouraging the account holder to engage in particular account activities that may produce larger fees, interest collections, and/or other revenue for the financial institution. For example, as an incentive to put money on deposit with a financial institution, and keep it there, a financial institution may reduce fees, and/or increase interest paid, as the amount on deposit by a customer with the financial institution increases. In this case, the revenue lost by the banking entity due to reduced fees and increased interest payments to the account holder is more than offset by earnings gained by the financial institution from use by the financial institution of the larger amount of money made available by the depositor.

Credit card issuers, in particular, have employed a variety of schemes to encourage customers to open credit card accounts and to use those accounts in ways that will bring more revenue to the credit card issuer. For example, a credit card issuing financial institution may advertise a very low initial interest rate to encourage customers to open accounts. (These low interest rates may be increased at a later date.) Once an account is opened, the credit card issuer may try to encourage active use of the credit card account by providing the customer various incentives or rewards. For example, the card holder may be provided a reward, either in the form of cash back, discount certificates, etc., in relation to the purchases made by the customer using the account. The more that the customer charges to the account, the greater the reward provided. The reward may be provided by the financial institution itself or provided in association with a particular merchant or group of merchants with which the financial institution has established a joint marketing relationship. Thus, the reward may be points that can be used for discounts at a particular merchant or group of merchants, such as “frequent flyer” miles that may be redeemed for travel on a particular airline or airlines. Additionally, purchases at the particular merchant or merchants involved in such a partnering relationship may result in more valuable rewards, or the more rapid accumulation of points toward achieving a reward threshold level. In another scheme, credit card issuers may offer an entry into a drawing for prizes each time a credit card holder uses a credit card associated with a particular account over a certain period of time. Thus, the credit card holder is encouraged to use his credit card often, thereby to increase his chances of winning a prize.

A great disadvantage of most current schemes for encouraging customers to open and use various financial accounts, such as credit card accounts, is that there often is a disconnect and delay between the customer's use of the account and the providing of the benefit or reward. For example, a customer who is rewarded with a cash back bonus, discounts, “frequent flyer” miles, etc. for using a credit card does not receive the benefit of the reward until well after he has used the credit card many times. In the example described above of providing an entry into a prize drawing for each time a credit card account is used, the customer probably will never receive any prize or even any indication he was actually entered to win a prize. This disconnect between the rewards provided to encourage financial account holders to open accounts and to use their accounts in particular ways and the account holder's actual behavior in this regard reduces the effectiveness of the rewards in actually causing the account holder to alter his behavior in the way desired.

What is desired, therefore, is an improved and effective system and method for encouraging a customer to open and actively use financial accounts, such as credit card accounts, and to reward the customer for engaging in particular account activities in a manner that is likely to cause the customer to alter his behavior in this regard. Such a system and method preferably is implemented for substantially automatic operation in a computer based system.

### SUMMARY OF THE INVENTION

The present invention provides a system and method for rewarding holders of financial accounts, e.g., credit card account holders, for engaging in certain activities associated with those accounts. In accordance with the present invention, incentives are provided and managed in such a way as to encourage effectively specific types of account activity and use which, ultimately, increase revenue to the financial institution providing the account to the customer. A financial account up-front incentives management system and method in accordance with the present invention may feature a variety of types of incentives, each of which effectively transfer value from a financial institution to a customer account holder to encourage or reward specific customer behavior with respect to a financial account. An up-front incentives management system in accordance with the present invention preferably is implemented as an integrated multi-tiered process for managing, in an automated manner, a variety of incentive elements that may be provided to a customer to encourage specific behavior. Preferably, each element of the process or type of incentive offered may be turned on or turned off by product, financial institution, or on an individual customer basis by the user of a system in accordance with the present invention. Exemplary component elements or types of incentives that may be provided and managed by a financial account up-front incentives management system in accordance with the present invention include rewards, discounts, and prizes. Rewards are incentives earned by an account holder for using his account on a regular basis and/or in a particular way. Discounts are reduced prices and rebates on products or services purchased by using a specific account at a specific merchant or on a specific product. Prizes are gifts or bonuses given to customers for activating or maintaining an account. In accordance with the present invention, different incentive types preferably all may be administered through a single integrated up-front incentives management system, with a single account statement automatically generated by the system from data received on a regular basis, generally monthly, from various financial institution accounting and customer database systems. In accordance with the present invention, rewards, discounts, and prizes are presented to a customer and managed in such a way as to maximize the effectiveness of the incentives in encouraging specific behavior by the customer with respect to his financial accounts while minimizing the cost of managing such a system by a financial institution. In accordance with the present invention, an incentive may be provided to a customer account holder before the account holder has engaged in a desired activity based on the customer's agreement to engage in the desired activity in the future. A penalty may be charged to the customer's account if the account holder fails to satisfy the agreement.

Incentives provided to customers by an up-front incentives management system and method in accordance with the present invention are intended to encourage customers to use their accounts on a regular basis or in a particular way. Operationally, incentives may be implemented to work similarly to a frequent flyer program common in the airline industry. Each time a customer uses his account he earns points. These points are accumulated over time and are credited to his account. The customer can exchange his points at any time for a specific reward. In accordance with the present invention, a customer may also borrow up-front points at any time or at selected times (e.g., upon opening an account or during other promotional periods). In accordance with the present invention, rewards may be administered via certificates issued to account holders at the account holder's request for specific reward merchandise or services from a catalog, on-line product listing, or listing included on the account holder's statement. The certificate may then be redeemed (either physically or electronically) for the chosen merchandise or specific value at a given merchant. Exemplary reward items may include electronics, travel, vacation packages, jewelry, home furnishings, etc.

In accordance with the present invention, rewards may be provided to customers as up-front incentives. Up-front incentives are specific rewards that may be chosen by a customer in advance of anticipated account activity, such as opening an account or making a series of purchases using the account. The account holder agrees to engage in specific account activity (i.e., using the account to make a minimum number of monthly purchases or maintaining minimum monthly balances over a contracted period of e.g., one to two years). If the account holder fails to meet these commitments, his account may be charged for the retail value, or a portion thereof, of the up-front reward that was provided to him. Up-front incentives also may be provided to customer account holders based on a combination of past and anticipated account activity. For example, an account holder may be given a reward for opening an account and/or achieving a certain account balance (e.g., by transferring other credit card balances to and/or taking a cash advance from a credit card account) (past activity) as well as for agreeing to maintain a minimum account balance over a period of time (anticipated activity). This further reduces the risk that a customer who is given an up-front incentive will not engage in any anticipated account activity, since at least some desired activity is required to receive the reward.

In accordance with the present invention, incentive points may be earned for any transaction that can be documented and electronically transferred to an up-front incentives management system in accordance with the present invention. As an example, incentive points may be earned for charges to credit cards, cash advances, payments, balances maintained, balances transferred, deposits, withdrawals, or any such activity in a related account. In addition, incentive points may be enhanced through participation of merchants or service providers. For example, purchasing airline tickets from an airline partner using a particular credit card account may earn double points for the account (e.g., two points per dollar purchased rather than one point). Purchasing a TV at an electronics retail partner using the account may earn double points for the purchase.

In some cases an incentive may be provided to a customer for engaging in a one-time account activity or a limited number of activities (e.g., opening an account and maintaining a minimum account balance).

In addition to administering the points allocation process, an up-front incentives management system in accordance with the present invention preferably also automatically administers rewards generation, distribution and redemption processes. Such processes may include, for example, rewards certificate issuance, rewards redemption expiration and tracking, and the accounting of outstanding and redeemed rewards. The system preferably also generates statement information related to rewards for inclusion into the financial institution's existing statement generation process. In addition, the system also preferably may handle the billing of merchants for their participation in double points or other incentive programs tied in or related to the rewards program.

An up-front incentives management system and method in accordance with the present invention also may provide for and manage the provision of discounts to customers to encourage specific account activity by the customer account holders. Discounts may include both discounts at the time of purchase of products and/or services and rebates related to purchases already made. Discounts may include pre-negotiated discounts for customers who use their accounts to purchase specific merchandise and/or utilize a specific provider, e.g., within a given time frame. Examples of discounts may include: “25% off next purchase of a Sony TV”, “Buy one dinner get one dinner free”, “30% off all purchases made next week at Home Depot”, etc. Rebates are discounts granted after the customer has fulfilled specific purchase requirements using their account and are intended as enticements to encourage the customer to repeat business with a merchant using the customer's account. Examples of rebates may include: “You just purchased a PC, come back and get a free printer”, “You just purchased a new refrigerator, come back and get a free set of cook wear”, “You just purchased your tenth CD, come back and get a free CD”, etc. Both discounts and rebates typically may be funded by the vendor, merchant, or service provider selling the goods or services to which the discount or rebate applies. An up-front incentives management system and method in accordance with the present invention preferably lists automatically the details of all discounts and rebates available to the customer in each current customer account statement. The listing of discounts and rebates in the customer's account statement is subject to the merchant providing merchandise availability and other data to the financial institution's processing system in which an up-front incentives management system in accordance with the present invention is implemented.

An up-front incentives management system and method in accordance with the present invention also may provide for and manage the providing of prizes to customers to encourage particular account activity. Prizes may be intended, for example, to encourage numerous small transactions by a customer using a particular account and to keep the account active. Prizes may include generic prizes for every account holder who accomplishes a particular account activity (e.g., maintaining a specific spending or balance level over a fixed period of time). Examples of generic prizes could include: “Free credit protection service if you make three purchases this month”, or “Free Ginsu knives if you charge over $300 this month on your credit card”, etc.

Prizes also may include sweepstakes entries and drawings based upon individual purchases or deposits or other account activities within a promotion period. Management of sweepstakes entries by a system in accordance with the present invention includes managing the specific criteria necessary for getting an entry into the sweepstakes and administering the entry numbers. In accordance with the present invention, sweepstakes may be administered at three levels. At level one an entry into the sweepstakes is obtained by the customer based upon achieving specific account activity criteria (e.g., one entry into the sweepstakes per purchase made using the account). The second level is matching this entry number against a “public” number to be eligible for a grand prize drawing. The third level is selecting a fixed number of grand prize winners from the eligible entries.

For example, as a reward for complying with a financial institution's objectives, each customer account holder who satisfies selected account activity criteria may be entered into a series of drawings which will result in various prizes being awarded to one or more of the account holders. Prizes may be awarded on a periodic basis, e.g., daily, weekly, monthly, or in another time frame, and may range from small nominal prizes (e.g., movie tickets) to large incentive prizes (e.g., automobiles). Being a winner of a small prize may be used as criteria for being eligible for a subsequent prize drawing for a more substantial prize.

By using an account as directed by the financial institution (e.g., making purchases, keeping the account current, making payments in a timely fashion, using the account at selected (partnering) merchants, etc.), the customer will automatically be entered into a drawing for a prize. Entries may be based on time criteria (e.g., one entry per account per month) and/or activity criteria (e.g., one entry per purchase). (The process for obtaining an entry into a drawing must, of course, comply with local laws regarding such lottery type events and may require entry into the prize drawing via paper forms being received and processed as well.) In accordance with the present invention, entries preferably may be made and processed automatically from system-generated transactions by extracting account activity information from monthly statement file data or daily all items transaction file data available from the financial institution's account processors. (Additionally, entries may be made manually by entering entry data obtained from paper entry forms.) All entries must each have an expiration date or expiring event, i.e., the prize drawing.

In accordance with the present invention, winners of sweepstakes prizes are selected based upon random chance and are not prearranged or directed in any way. Thus, each entry must have the exact same probability of winning as every other entry. Several methods may be used to implement such a system for awarding prizes to sweepstakes winners. For example, a fixed number of winners may be predetermined and each winning entry selected sequentially based upon individual random choice. The winner selection process may thus be based upon a random number matching the entry number. Once an entry has been selected for a prize the winning entry is removed from the pool of eligible entries for subsequent drawings. Alternatively, a winning lottery number may be determined outside the system (e.g., by basing the winning number on a national or regional lottery number). The externally determined “public” winning number is matched against a previously assigned number associate with the entrant (e.g., the account number, the transaction number, a randomly generated or selected entry number, etc.). In this case, the number of winning entries will vary based upon the random matching of the externally determined winning number to the entries. (For example, if the winning number is a five digit winning number from a national lottery, and the potential matching entries are the last five digits of eligible customer account numbers, then the number of potential winners may range from zero to every eligible account in the database.) Combinations of prize winner selection techniques, where winners from a first selection process are entered into a second selection process, also may be employed.

In accordance with the present invention, all information managed by the system for awarding prizes is subject both to internal and external review for compliance with applicable laws. Integrity of data, selection criteria, and statistical analysis necessary for compliance preferably are provided by the system. (Violations may be costly in that the penalty may be to award a prize to all entrants.) In accordance with the present invention, all information about the individual entries and the numbers necessary for them to win are kept secure so as to prevent any potential biasing of the process. If the winning entry number is pre-known (e.g., the account number) then the selection of a winning number must be completely secure, unbiased and statistically random. Security of entry data and the selection process is critical. No user may be able to influence this process. In accordance with the present invention, several levels of security preferably are provided, including one for entry of entries data, one for loading data from financial institution processors to generate entries automatically, one for report selection, one for system administration, and one for the execution of the drawing itself. The system preferably automatically runs simulations against the entries in the database and produces statistical reports that can demonstrate the true randomness of the process and the probability of winning. The system preferably automatically produces letters, phone lists, or other listings of contact information (e.g., e-mail addresses) that can be used to notify winners that they have won a prize, what prize they have won and/or what drawing they are now entered into. The system preferably produces automatically a list of winners for independent audit verification and potential publication. A database of qualified (e.g., having provided a pre-paid handling fee, or self addressed stamped envelope) individuals that request winner lists may be maintained by the system and such winner lists may be generated automatically for delivery to such individuals.

Further objects, features, and advantages of the present invention will be apparent from the following detailed description taken in conjunction with the accompanying drawings.

### BRIEF DESCRIPTION OF THE DRAWINGS

FIG. 1 is a schematic flow chart diagram of a general exemplary financial account up-front incentives method in accordance with the present invention.

FIG. 2 is a schematic flow chart diagram of an exemplary method for determining the form of and individuals targeted to receive financial account up-front incentive offers in accordance with the present invention to optimize return on the incentives program.

FIG. 3 is a schematic diagram of an exemplary system for implementing a financial account up-front incentives management system and method in accordance with the present invention.

FIG. 4 is a schematic diagram illustrating the main functional and data components of an exemplary financial account up-front incentives management system and method in accordance with the present invention.

FIG. 5 is a schematic diagram illustrating basic data file organization and the relationships between data for an exemplary financial account up-front incentives management system and method in accordance with the present invention.

FIG. 6 is a flow chart diagram illustrating an exemplary process for loading customer data for use in a financial account up-front incentives management system and method in accordance with the present invention.

FIGS. 7 and 8 are flow chart diagrams illustrating an exemplary process for reward points processing in a financial account up-front incentives management system and method in accordance with the present invention.

FIGS. 9-11 are flow chart diagrams illustrating an exemplary process for reward certificate processing in a financial account up-front incentives management system and method in accordance with the present invention.

FIGS. 12 and 13 are flow chart diagrams illustrating an exemplary process for reward certificate redemption processing in a financial account up-front incentives management system and method in accordance with the present invention.

FIGS. 14 and 15 are flow chart diagrams illustrating an exemplary process for account statement processing in a financial account up-front incentives management system and method in accordance with the present invention.

### DETAILED DESCRIPTION OF THE INVENTION

The present invention provides a system and method whereby a financial institution or other entity may provide incentives to financial account holder customers to encourage particular types of account activities which will result in increased revenue to the financial institution. The present invention will be described in detail herein with reference to credit card type financial accounts and to credit card type account activities. It should be understood, however, that the present invention is not limited to credit card accounts and activities, but may be applicable to any type of financial account that may be offered to customers by a financial institution or other entity as well as to any type of account activity in which a customer may engage with such an account.

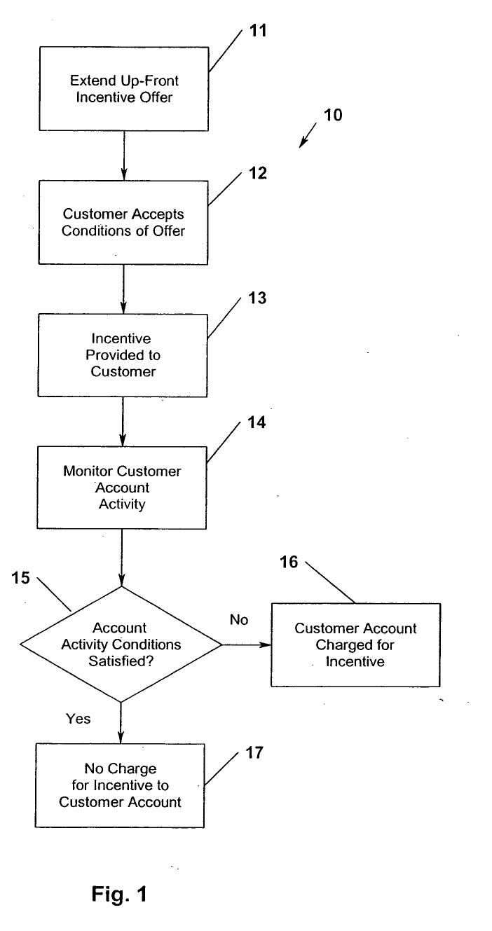

In accordance with the present invention, an incentive is provided to a customer account holder in an up-front manner to encourage desirable account activity. A flow chart illustrating an exemplary method 10 for implementing a generic financial account up-front incentive in accordance with the present invention is illustrated in, and will be described in more detail with reference to, FIG. 1. An up-front incentive offer is extended to existing and/or potential financial account holders (e.g., credit card account holders) at 11. As will be discussed in more detail below, since an up-front incentives program requires that an incentive be provided to a customer before desired account activity takes place, there is more up-front cost and thus risk to the entity running the program. A method for reducing the risks involved by better identifying the program specifics and eligible participants who will be offered an up-front incentive will be described in more detail below. The extended 11 up-front incentive offer identifies both an incentive (e.g., a merchandise reward) as well as financial account activity required to be engaged in by the customer (e.g., opening an account, maintaining a minimum account balance for a defined period, engaging in a minimum number of account transactions, etc.). The offer 11 may be presented to selected customers in a variety of conventional ways, e.g., as a directed mailing, phone solicitation, e-mail or other electronic communication, etc.

A customer may accept 12 the conditions of the up-front incentive offer in a variety of ways, such as by return mail or e-mail, over the telephone or via an internet web site, etc. By accepting 12 the offer, the customer agrees to engage in certain defined account activities in exchange for the up-front incentive. By accepting 12 the offer, the customer may also agree that, should he fail to engage in the prescribed account activities, his account (either the account for which he has agreed to engage in specified account activities or another customer account) will be charged for at least a portion of the value of the up-front incentive offer. Having agreed to the terms of the up-front incentive offer, the incentive is provided 13 to the customer in an up-front manner, i.e., before some or all of the agreed-to account activity is engaged in by the customer account holder. The incentive may be provided 13 directly to the account holder, e.g., by shipping merchandise to the account holder, or may be provided in the form of a reward certificate that may be redeemed, e.g., at a partnering merchant, for an incentive reward in the form of goods and/or services. In the case where the customer's account is awarded reward points (redeemable for merchandise or service rewards) for engaging in selected account activities, the incentive may be in the form of advanced or loaned reward points.

A financial account up-front incentives system in accordance with the present invention preferably automatically monitors 14 customer account activity to determine 15 automatically whether or not the account activity conditions that the account holder agreed to engage in have been satisfied. If the account activity conditions agreed to have not been satisfied by the customer account holder, the customer account (or a related customer account) may automatically be charged 16 for all or a portion of the value of the incentive provided. If the account activity conditions are satisfied the customer account is not charged 17. A detailed system and method for implementing and managing financial account up-front incentives of this type, including variations thereof, will be described in more detail below.

In a financial account up-front incentives program an incentive of value is provided to a customer account holder before the customer engages in agreed to account activity. Even if a portion of the value of the incentive is charged to the customer account for failure to engage in the agreed to account activity, an up-front incentive program requires more Lip-front expenditure and can represent greater risks than conventional financial account incentive programs where incentives are provided to a customer only after the customer has engaged in the desirable account activity. In order to minimize these risks it is important to identify the program characteristics and individuals who are to receive the up-front incentive offer in order to maximize the number of those who both accept the offer and who actually engage in the desired account activity after the incentive is received. In this way the potential benefit to the financial institution or other entity running the financial account up-front incentive program can be maximized.

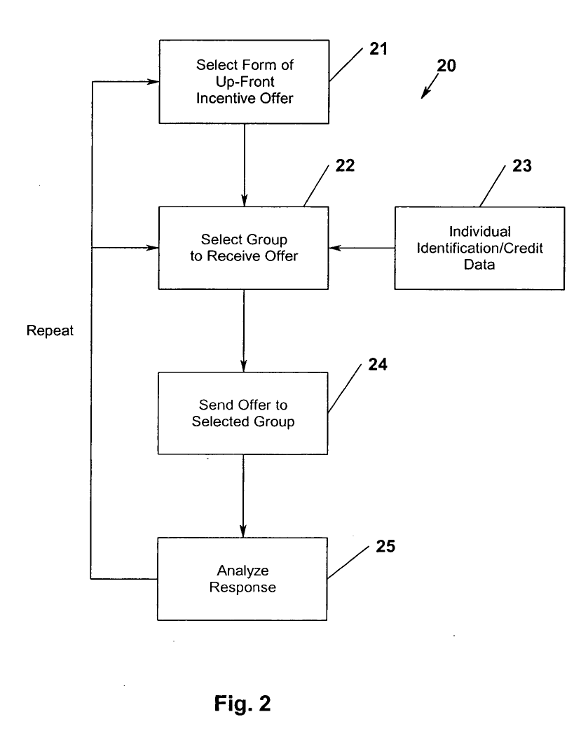

An exemplary method for identifying optimal characteristics of the financial account up-front incentives offer to be made, as well as those to make the offer to, is illustrated in, and will be described in more detail with reference to, the flow chart diagram 20 presented in FIG. 2. The initial characteristics of a financial account up-front incentive offer are first selected 21, e.g., based on experience with such offers or similar offers. The variable characteristics of the incentive offer that may be selected 21 may include how the offer is presented (by mail, by phone, etc.), the type and value of the incentive offered, the amount to be charged to the customer account for failure to engage in the agreed-to account activities, etc. A group of individual customer account holders, or prospective customer account holders, is then selected 22 to receive the selected 21 up-front incentive offer. As an initial matter a relatively small group of individuals (e.g., 10,000 recipients of a mailing offer) may be selected with little reference to individual credit bureau or other identification data 23 for those individuals. The selected incentives offer is then sent 24 to the selected group of individuals. The response to the offer and, particularly, the characteristics of those individuals who both accepted the offer and engaged in the desired account activities, i.e., met the up-front incentive conditions, are analyzed 25 to identify those identifying characteristics (income, past account activity, etc.) that indicate good prospects for such up-front incentive offers. Traditional statistical or other analysis may be used. The results of the analysis 25 are used to optimize the form of the offer 21 and identifying characteristics of the individuals to whom the offer is to be extended 11. The process may be repeated several times to optimize the effectiveness of the up-front incentive program.

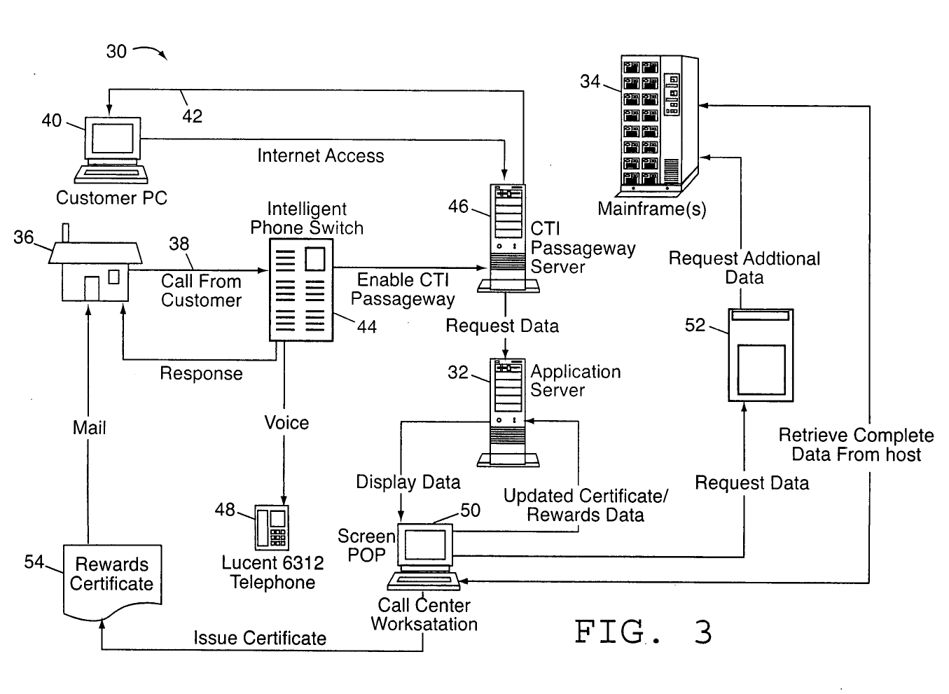

An exemplary financial account up-front incentives management system 30 in accordance with the present invention will be described in detail first with reference to FIG. 3 which illustrates exemplary components that may be employed to implement such a system and overall operation thereof. An up-front incentives management system in accordance with the present invention preferably may be integrated into the computer architecture and network currently used by a financial institution to perform account processing and management and other functions. Thus, the present invention may be implemented using commercially available computer hardware as currently employed by financial institutions to implement conventional account processing and management functions. When integrated into a financial institution's existing computer architecture and network, the present invention provides an integrated solution for transferring automatically value from the financial institution to its customers by rewarding particular desirable account activity by the account holder.

A financial account up-front incentives management system in accordance with the present invention preferably may be implemented on a conventional computer system operating as an application server 32. The application server 32 may be implemented using one or more convention computer systems with the processing power thereof selected based on the volume of accounts and incentives to be processed, the operating speed desired, system costs and availability and any other conventional criteria for selecting computer systems to perform specified functions. The application server 32 is linked in a conventional manner, e.g., via a local (e.g., Ethernet) and/or remote (e.g., the Internet) connection, to one or more various data processing systems 34 or vendors of the financial institution implementing a financial account up-front incentives management system 30. From these various data processing systems 34 and vendors the up-front incentives management system 30 obtains data necessary to implement the various processes described below. Such data includes, for example, financial account related data, including data related to financial account activities, as will be discussed in more detail below. It should be noted that a financial account up-front incentives management system in accordance with the present invention may be implemented on an application server 32 computer system separate from the other financial institution data processing system computers 34, as illustrated in FIG. 1, or as part of such financial institution data processing systems 34.

Customer account holders 36 may access account incentive information from the financial account up-front incentives management system 30 either through a telephone call 38 to a customer service center of a financial institution implementing the system or via a conventional personal computer 40 linked to the system via a conventional remote connection. For example, the customer's personal computer 40 may be linked to the application server 32 on which the financial account up-front incentives management system is implemented via a conventional Internet connection 42. For telephone communications, the application server 32 on which the financial account up-front incentives management system is implemented may be linked to customer calls placed to the call center via a conventional intelligent phone switch 44 and an integrated CTI (computer telecommunication integration) switch 46 which will allow customer's to use touch tone telephones to interact with their accounts. If in-person customer service is required, the incoming customer call may be switched by the phone switch 44 to a conventional telephone 48. The telephone 48 is operated by a customer service operator who also is provided with a workstation computer 50 that is coupled to the application server 32 such that the operator may obtained desired account information related to customer account incentives therefrom. The application server 32 preferably is programmed to interface with the phone switch 44 and the call center workstation 50 to invoke automatically and immediately a “screen-pop” or other link to the customer's relevant account data that will appear on the workstation when a call is switched to the phone 48, to allow for seamless service. Thus, an account holder who has already entered his account number into the system via his touch tone-telephone and then is switched to a customer service operator phone 48 will have his account information automatically appear on the operator's workstation 50 at the time of the switch without having to give any additional information to the operator to be keyed in. The operator's workstation 50 preferably also is coupled via a customer care system interface 52 to the financial institution's main computer system 34 or other vendor systems such that the customer service operator has access to all information relevant to a customer's financial account, including information not necessarily related to account incentives, so that the operator may provide complete service to the calling customer.

A financial account up-front incentives management system 30 in accordance with the present invention also may communicate with customer account holders 36 via conventional mail or other hard copy delivery systems. For example, reward certificates 54 issued by the system preferably are delivered to customer account holders through the mail or other hard copy delivery systems. A customer account holder may request a reward certificate to be issued by calling or otherwise communicating with the customer service center in the manner discussed above. In response to such a request, and if all of the requirements for issuing a reward to the customer have been satisfied, the financial account up-front incentives management system 30 may print and mail (using conventional printing and mailing equipment) a reward certificate 54 (which may be redeemed by the customer at, for example, a selected merchant) to the customer account holder. Account statements also may be generated by the system and delivered to the customer account holder via hard copy mail or electronically, as will be discussed in more detail below.

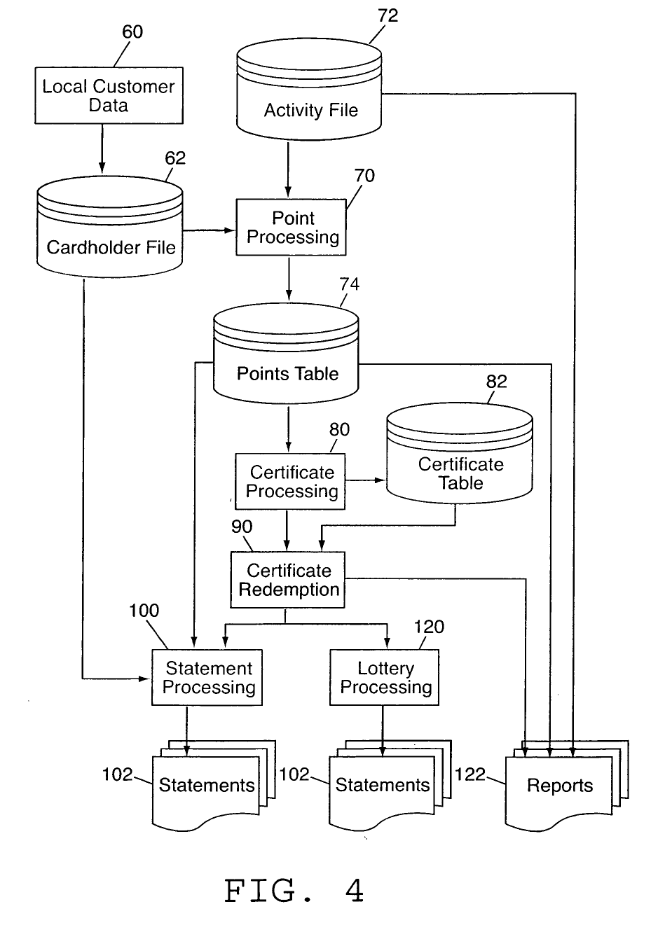

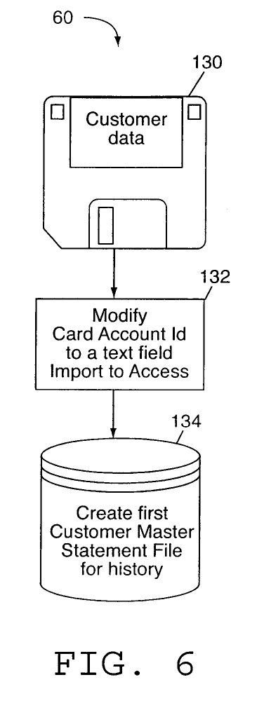

The main functional and data components of an exemplary financial account up-front incentives management system and method in accordance with the present invention now will be discussed with reference to the schematic diagram of FIG. 4. In a customer data load process 60 a series of programs import customer account data into a financial account up-front incentives management system 30 in accordance with the present invention from one or more financial institutions or other data processors. Each interface between the up-front incentives management system 30 and an outside data processor may be isolated with a different load data program. Data to be loaded into the system may be loaded via batch transfers, on-line transaction transfers, and/or real-time network transfers, such as via an ODBC link, depending upon the types of systems and data involved. The loaded customer data is used to define and establish the customer accounts that will be participants in a financial account up-front incentives management method in accordance with the present invention. For example, customer data identifying customer credit card accounts that are eligible to receive incentives may be loaded 60 and stored in a cardholder file database 62 for use by the system. An exemplary customer data load process will be described in more detail below with reference to FIG. 6.

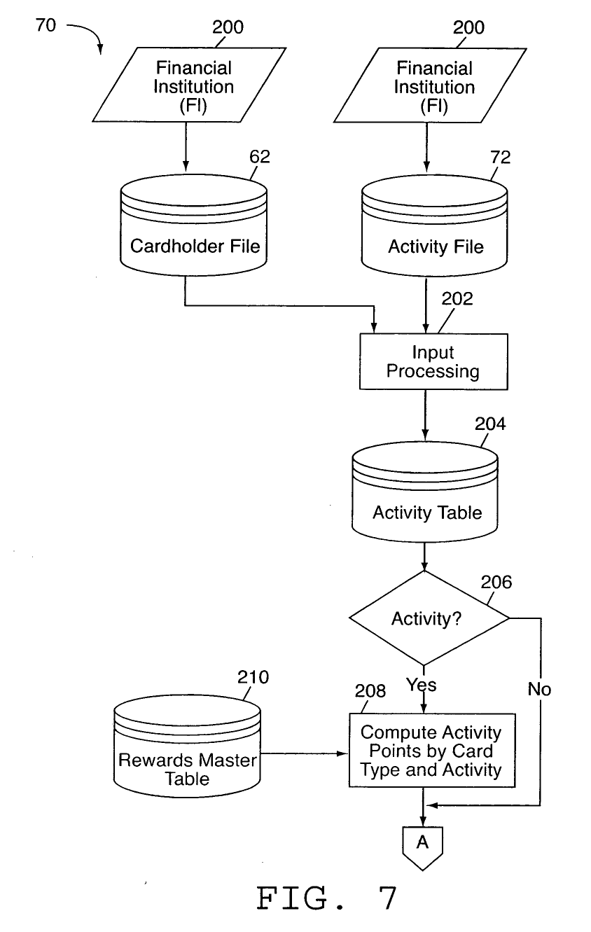

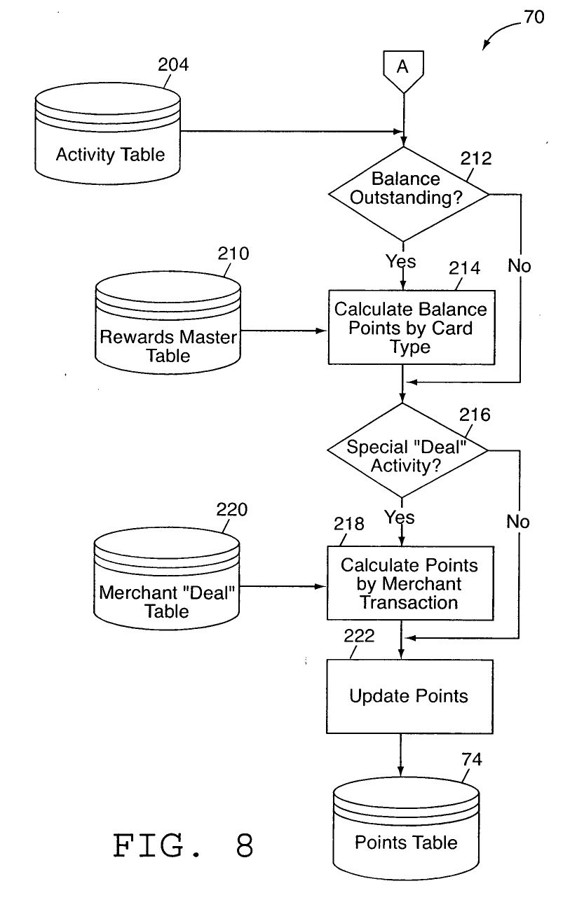

In accordance with the present invention, a customer account holder may earn points toward receiving an incentive or satisfying established incentive criteria by engaging in one or more types of account activities. A point processing function 70 of a financial account up-front incentives management system in accordance with the present invention monitors customer account activity as provided to the system by the financial institution managing the customer account. Account activity data used for point processing may be stored in an account activity file database 72. The point processing function 70 assigns reward points to customer accounts, as defined, e.g., in the cardholder file database 62, based on the reported account activity according to rules set forth in the system. The point processing function 70 may increase or decrease the point balance for a customer account based on the account activity and applied rules. For example, points may be added to a customer account for each purchase made using the account and points subtracted from a customer account for failure to maintain a particular account balance. Customer account points established by the point processing function 70 may be stored in an account points table database 74. Preferably, a user of the system may access the points table database 74 to manage and adjust as necessary the account point totals stored therein. An appropriate graphical user interface to the points table database 74 may be provided for this purpose. The points processing function 70 will be described in more detail below with reference to FIGS. 7 and 8.

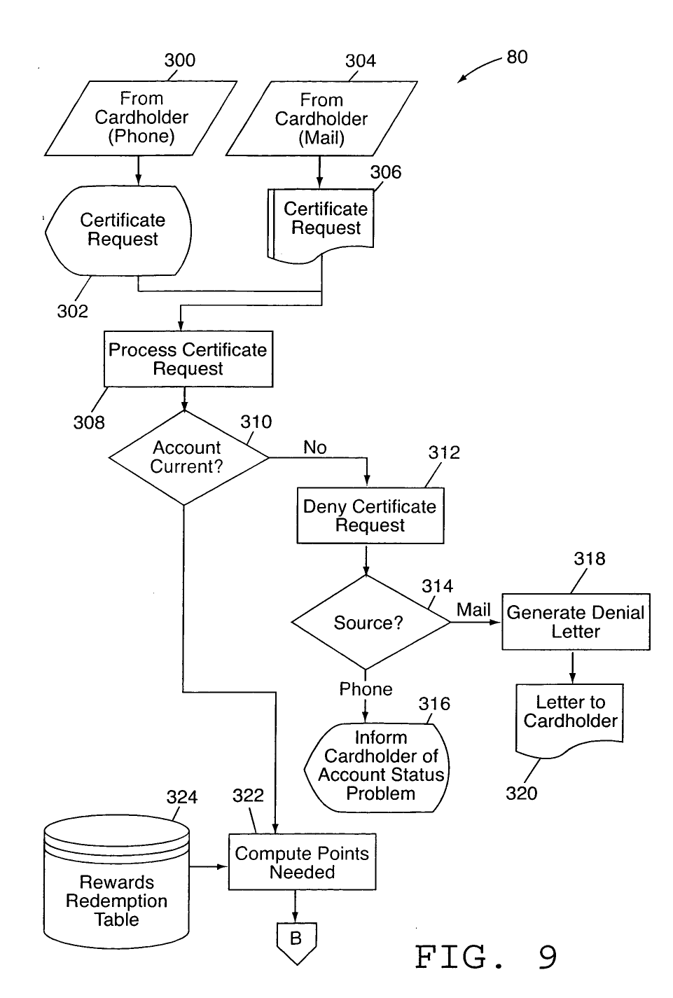

In accordance with the present invention, a customer account holder who has engaged in selected account activity, or who has agreed to engage in such activity in the future, may be issued a reward in the form a reward certificate 54 that may be redeemed by the customer for goods or services at a selected merchant or merchants. The certificate processing function 80 of a financial account Lip-front incentives management system 30 in accordance with the present invention allows account reward points, as recorded in the points table database 74, to be redeemed and award certificates 54 to be issued. In accordance with the present invention, reward certificates 54 also may be issued based upon an agreement by the customer account holder to engage in specified account activity in the future. Extreme security measures are employed by the certificate processing function 80 to assure the integrity of the system. Preferably each reward certificate 54 issued by the system has an imprinted serial number. The imprinted certificate card stock may be pre-loaded into a printer in a secure location. As certificates 54 are issued by the certificate processing function 80, a unique number is generated and printed on the reward certificate 54. The combination of system generated and pre-printed control numbers is used to ensure security. Printed reward certificates 54 may be mailed or otherwise delivered to the customer account holder in the manner described above. A record of each reward certificate 54 available to be issued and issued by the certificate processing function 80 is maintained in one or more certificate table databases 82. The certificate processing function 80 will be described in more detail below with reference to FIGS. 9-11.

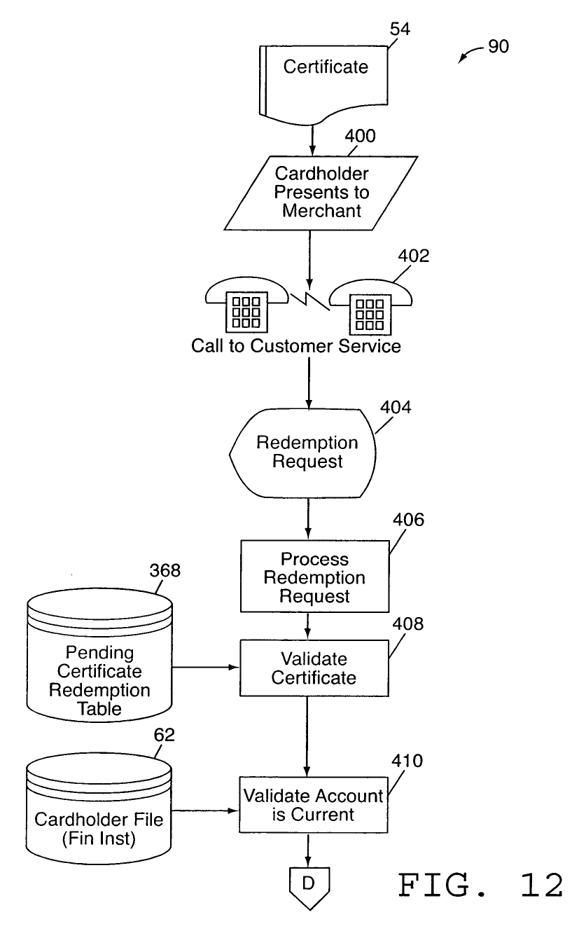

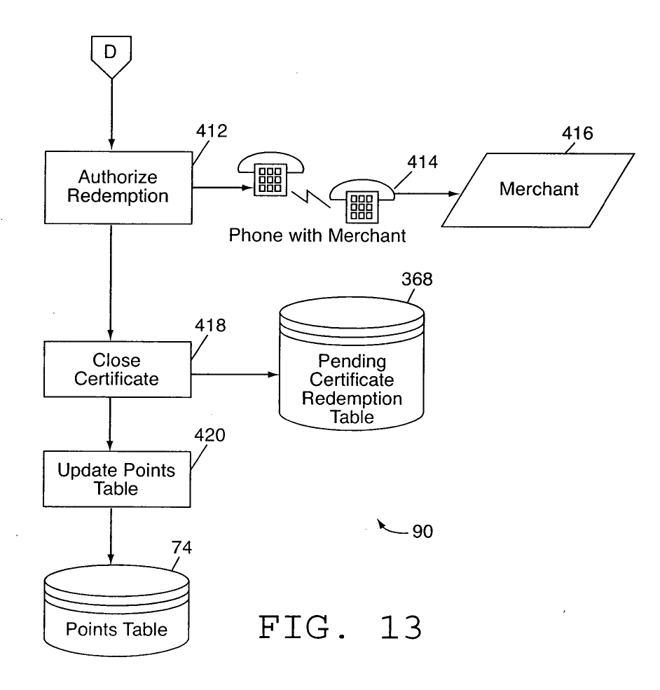

A certificate redemption function 90 is employed when a customer account holder redeems a reward certificate 54 for goods or services. When a reward certificate 54 is used by a customer, the merchant with which the certificate 54 is to be redeemed is responsible for calling in or electronically transmitting the certificate number to the financial account up-front incentives management system 30 for verification before the certificate 54 can be used. The certificate redemption function 90 verifies that the identified certificate is recorded in the certificate table database 82. At that time the merchant may be given a reward certificate verification code that the merchant will write on the certificate 54 confirming redemption thereof. The redeemed reward certificate is then returned to the financial account up-front incentives management system 30 by the merchant for further processing. When the redeemed certificate is received back by the system 30 the certificate redemption function 90 verifies the authenticity of the redeemed certificate by examining the verification code written on the redeemed certificate. Only if the verification code written on the certificate matches the verification code for the certificate as indicated in the certificate table database 82 is the certificate considered valid. The merchant may then be billed according to a system-generated transaction file. An exemplary certificate redemption function will be described in more detail below with reference to FIGS. 12 and 13. The certificate management processes 80 and 90 preferably also automatically handle such exceptions as lost (unredeemed) certificates, blank certificates mis-fed into the certificate printer, etc.

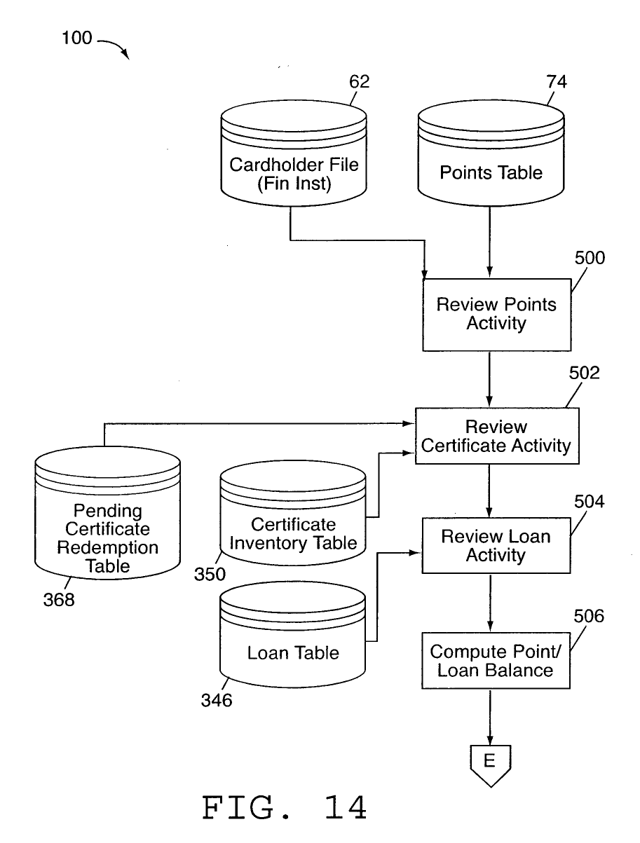

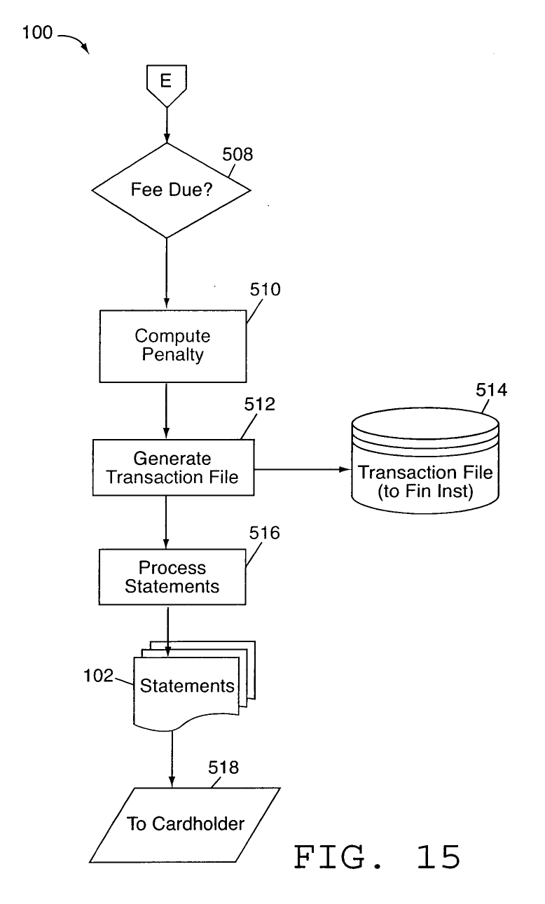

A statement processing function 100 may be used to generate detailed statements 102 on a periodic basis (e.g., monthly) to show detailed activity on the customer accounts, e.g., cardholder accounts identified in the cardholder file database 62, with respect to incentives. Each statement 102 preferably includes detailed transaction level detail on all account activity affecting incentives for the period. For example, all activities affecting account reward points and the number of points added to or removed from the cardholder account may be included in the statement 102. Points information for inclusion in the statements 102 may be obtained from the points table database 74. Also, a detailed description of any point or certificate redemptions or incentives earned or payments due for up-front incentives provided to the customer but not earned maybe provided in the account statement 102. As discussed above, account statements 102 may be mailed or delivered electronically to customer account holders. The statement processing function 100 may be implemented in an integrated manner with the general account statement generation processes implemented by a financial institution such that the account incentives information generated by the statement processing function 100 for inclusion in the statements 102 may be included as part of the regular account statements provided to customers for their accounts. An exemplary statement processing function 100 will be described in more detail below with reference to FIGS. 14 and 15.

A financial account up-front incentives management system and method in accordance with the present invention may provide incentives to customer account holders to engage in specified desirable account activities in the form of entries into a lottery drawing for one or more prizes. A lottery processing function 120 is employed to implement and manage such a lottery incentives system. The lottery processing function 120 may be enabled selectively by account type, transaction type, financial institution, date of processing or other factors. The lottery processes implemented by the lottery processing function 120 may take the form of a number of different filters and random drawings at a number of levels leading to a potential winner. Customer account holder participation in lottery incentives preferably may be reported to customers by the lottery processing function 120 in the customer account statements 102. For example, the customer account statements 102 may indicate how many entries into a lottery drawing a customer has earned as a reward for engaging in particular account activities.

A financial account up-front incentives management system and method in accordance with the present invention preferably provides reports 122, either automatically on a periodic basis or upon request, to an operator of the system 30 so that the operator may monitor the status of incentives by customer account holders. For example, information such as customer account activity 72, the reward points 74 resulting from account activities, and the redemption 90 of reward certificates by account holders may be included in such reports 122. The operator of the system 30 preferably is able easily to format such reports 122 to obtain the information desired from the system 30 in a useful format so that the operator may monitor incentive programs implemented using the system 30. By the use of such reports 122 the operator is able to monitor how successful an incentive program is in causing customer account holders to engage in selected account activities, program costs, costs to be billed to partnering merchants, etc.

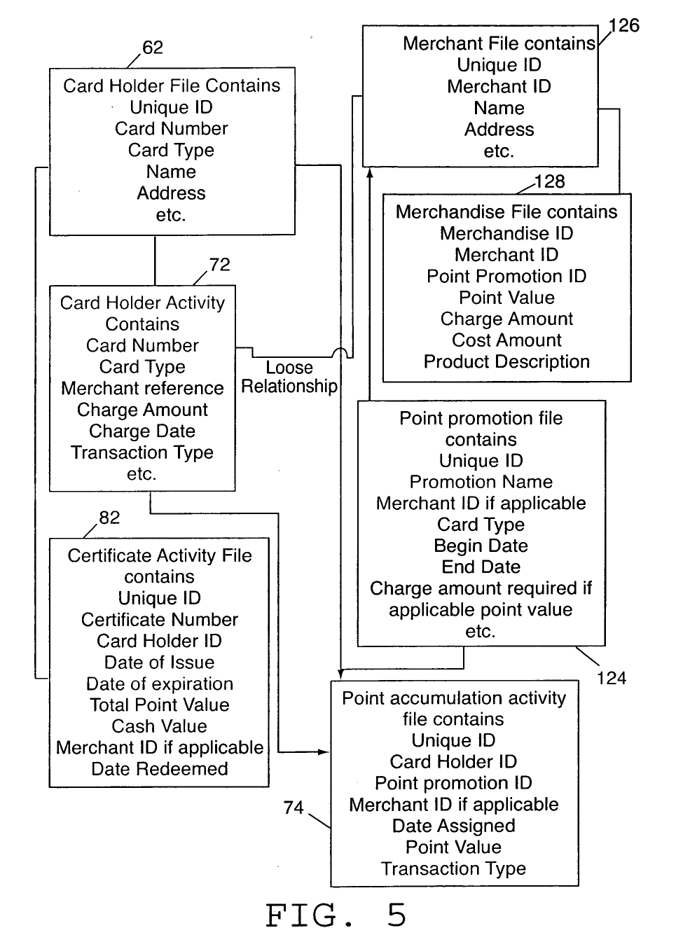

Exemplary data files that may be employed by a financial account up-front incentives management system and method in accordance with the present invention, and the relationships between the data in such files, are illustrated in, and will be described with reference to, FIG. 5. Each exemplary data file to be described may be stored in a separate database on separate or the same conventional memory devices. Standard database management software and techniques may be employed to store and retrieve the data discussed for use by the financial account up-front incentives management system in accordance with the present invention.

As discussed above, a cardholder file database 62 may be employed to store basic credit card account information for customer accounts that are eligible for rewards in a financial account up-front rewards management system and method in accordance with the present invention. Exemplary customer account data that may be included in the cardholder file database 62 includes a unique identification number to identify the customer account within the system (the unique number may be assigned by the system 30 when the account is added to the database 62), the credit card or account number, the credit card type, the customer name and address and/or other contact information, etc.

A cardholder activity file database 72 contains information related to account activities engaged in by customer account holders using the accounts identified in the cardholder database 62. Exemplary data that may be included in the activity database 72 includes the credit card or account number, the card type, merchant references to merchants at which purchases were made using the account, the amounts charged and dates those charges were made, information identifying a transaction type (e.g., purchase, cash withdrawal, credit for return, etc.), etc.

As discussed above, based upon the account activities identified in the activity database 72, and established rules, reward points may be associated with the customer accounts identified in the account holder database 62 by a financial account up-front incentives management system 30 in accordance with the present invention. Awarded points may be stored in a points database 74 wherein accumulated point activity is stored for later use by the system 30. Exemplary point accumulation activity data that may be stored in the points database 74 includes: a unique system identification number for the customer account, cardholder identification information, point promotion identification information, merchant identification information (if applicable), the date points are assigned (or deducted) from the point total, the point value of additions to or subtractions from the point total, the type of transaction or other activity resulting in the point reward (or deduction), etc. The point promotion identification and merchant identification information are used if points are earned because of account activity related to a particular promotion or merchant. For example, purchases of a particular product or from a particular partnering merchant using the account during a promotion period may result in the awarding of more points than purchases in general.

Information for point promotions that may be used to determine the points that are awarded for particular account activities, and stored in the point database 74, may be stored in a point promotion file database 124. Information included in the point promotion file database 124 may include a unique identification number for each point promotion (which number may be assigned by the system at the time a point promotion is established), a promotion name, a merchant identification (e.g., if the point promotion is limited to purchases made from a particular merchant or group of merchants), credit card type for which the promotion is applicable, beginning and end dates for the promotion period, a minimum charge amount (if required by the promotion), the number of points awarded for account activities falling under the promotion, etc.

Information for particular merchants involved in point promotions identified in the point promotion file database 124 may be stored in a merchant file database 126. Information included in the merchant file database 126 may include: a unique identification number assigned by the system 30 to the merchant, merchant identification information including the merchant name and address, etc. Note that there is also a loose relationship between the merchant information stored in the merchant file database 126 and the account activity information stored in the activity database 72 in that account activity information stored in the activity database 72 may identify a particular merchant identified in the merchant file database 126 at which the particular account activity (e.g., charge for purchase of goods or services) recorded in the activity database 72 took place.

Information for particular merchandise offered by merchants identified in the merchant file database 126 may be stored in a merchandise file database 128. Merchandise information stored in the merchandise file database 128 may be employed by a financial account up-front incentives management system and method in accordance with the present invention where, for example, a point promotion for a particular merchant or group of merchants requires purchase of a particular product or products to be made using the customer account in order for any points, or an increased number of points, to be awarded to the account under the promotion. Exemplary merchandise information that may be included in the merchandise file database 128 may include: a unique merchandise identification number (which may be assigned by the system 30 or may be the universal product code for the merchandise), the identification number for the merchant or merchants offering the merchandise for sale, the identification number for the point promotion under which points or enhanced points are awarded for purchases of the identified merchandise, a point value that will be awarded for purchases of the identified merchandise using an identified customer account, a minimum charge amount (if any) required to obtain the points for purchasing the identified merchandise, the cost of the identified merchandise, a description of the merchandise, etc.

As discussed above, as part of a financial account up-front incentives management system and method in accordance with the present invention an account holder identified in the card holder database 62 may be issued a reward certificate 54 as a reward for engaging in certain account activities or for agreeing to engage in specified account activities in the future. Information identifying reward certificates 54 issued to customers and activities associated therewith may be stored in a certificate activity file database 82. Exemplary certificate activity information that may be stored in the certificate database 82 may include: a unique identification number identifying the reward certificate, the certificate number, the identification number of the card holder to whom the certificate was issued, the date that the certificate was issued, the date that the certificate expires, the total point value of the reward certificate (the number of points required to be obtained for the certificate to be issued), the cash value of the reward certificate, the identification of a particular merchant or merchants at which the reward certificate must be or was redeemed, the date that the certificate was redeemed, etc.

A series of flow-chart diagrams now will be presented that describe in further detail exemplary methods for implementing the various functions of a financial account up-front incentives management system and method in accordance with the present invention. It should be noted that the present invention is not limited to the particular exemplary implementations illustrated in and described with respect to the flow chart diagrams presented herein. In particular, the various operational steps illustrated in the flow charts may be implemented in an order different from that illustrated and described and certain steps may be added, deleted, or modified to achieve desired operational criteria such as speed and/or efficiency of operation. Based on the detailed description in combination with the flow-chart diagrams and other figures provided herein a person of ordinary skill in the art of computer programming for financial account management applications will be able to implement a financial account up-front incentives management system and method in accordance with the present invention on a conventional computer system as described above using conventional programming languages and techniques.

An exemplary process for implementing the load customer data function 60 is illustrated in, and will be described with reference to, the exemplary flow chart diagram illustrated in FIG. 6. As discussed above, customer data 130 is imported from financial institution processors or other data sources that contain account information on customer financial accounts that will be participants in an up-front incentives program in accordance with the present invention. Customer account data 130 related to any type of financial account (e.g., credit card, DDA, savings, etc.) may be loaded into the system. Loaded customer data is converted 132 to an appropriate text format for use by a financial account up-front incentives management system in accordance with the present invention and added to an account database, e.g., the cardholder file database 62. If the customer data loaded into the system is for a new customer or account, rather than an update or addition to previously loaded account information, a master data record is created 134 for the new customer account.

An exemplary process for implementing the points processing function 70 is illustrated in, and will be described with reference to, FIGS. 7 and 8. Beginning with FIG. 7. As discussed above, in accordance with the present invention, points may be awarded to specific customer accounts based on customer account activities using those accounts. As also discussed above, customer account identification information, e.g., credit card account information, is formatted, filtered, and received for processing from the financial institution 200 that is maintaining the account and stored in a database, e.g., the cardholder file database 62. Similarly, data related to customer activity (e.g., transactions) using such accounts is formatted, filtered, and received for processing from the financial institution 200 and stored in an activity file database 72. At step 202 the account information from the cardholder database 62 and the account activity information from the activity database 72 are processed to match account activities to their corresponding account identifying information. The resulting matched activity and account information is stored, e.g., in an activity table database 204. A determination 206 then is made for each account whether there has been any account activity for the account since the last time the account was processed by the system. If there has been new account activity the points to be awarded to (or deducted from) the account for each account activity are calculated 208. As discussed above, the points to be awarded to (or deducted from) the account may be based on a variety of variables including, for example, the transaction type (e.g., purchase versus cash advance), date of the transaction, currency, the account used, the merchant from which the purchase was made using the account, etc. The rules defining the number of points assigned to a particular transaction may be embodied, for example, in a table stored in a rewards master table database 210.

Turning now to FIG. 8. After awarding points to the account based on new account activity (if any) a determination 212 may be made if there is a balance outstanding on any points on loan to the account. In accordance with the present invention customer account holders may be allowed to borrow points in order to obtain rewards that they have not yet earned with the understanding that future account activities will result in sufficient points being awarded to the account to offset the loaned points. If there are any points on loan, the current point balance is recalculated at 214 taking the loaned points into account. At 216 a determination is made whether or not any of the account activity qualifies for “special deal” point awards. For example, purchases from a specific partnering merchant or of a specific product using an account may result in additional points being awarded to the account. If any such special deals are applicable to any customer account activity the additional special points are calculated 218 based on applicable rules for the special deal that may be embodied, for example, in tabular form in a merchant deal table database 220, and added to the customer account. After all adjustments to the customer's account point total have been calculated, the point totals for the customer account (e.g., YTD, MTD, and daily point totals) are updated 222 and posted to the customer account point information stored in the points table database 74.

An exemplary process for implementing the rewards certificate processing function 80 is illustrated in, and will be described with reference to, FIGS. 9-11. Beginning with FIG. 9. A customer account holder may request that a reward certificate be issued to him in several ways. For example, a reward certificate request may be received from the customer via telephone 300, e.g., using a touch tone phone which is coupled to the up-front incentives management system 30 via a phone switch 44 as discussed above. Alternatively, a reward certificate request may be received from the customer via mail 304. In either case, the certificate request information, 302 or 306, received via phone or mail, respectively, is entered into the system and processing of the certificate request is initiated 308. An initial determination 310 may be made whether or not the customer account upon which the reward certificate request is based is current. If the account is not current, e.g., the customer is delinquent in making account payments, than the request for issuance of a reward certificate will be denied 312. If issuance of the reward certificate is denied the source of the certificate request is determined 314. If the source of the certificate request is a phone call, the requesting customer may be notified immediately over the phone 316 that his account is not in good standing and that, therefore, his request has been denied. If the certificate request was submitted via mail the system may generated a denial letter 318 that is mailed 320 back to the account holder. If the customer's account is current, the points needed to issue the reward certificate to the customer are calculated 322 using information stored in a rewards redemption table database 324.

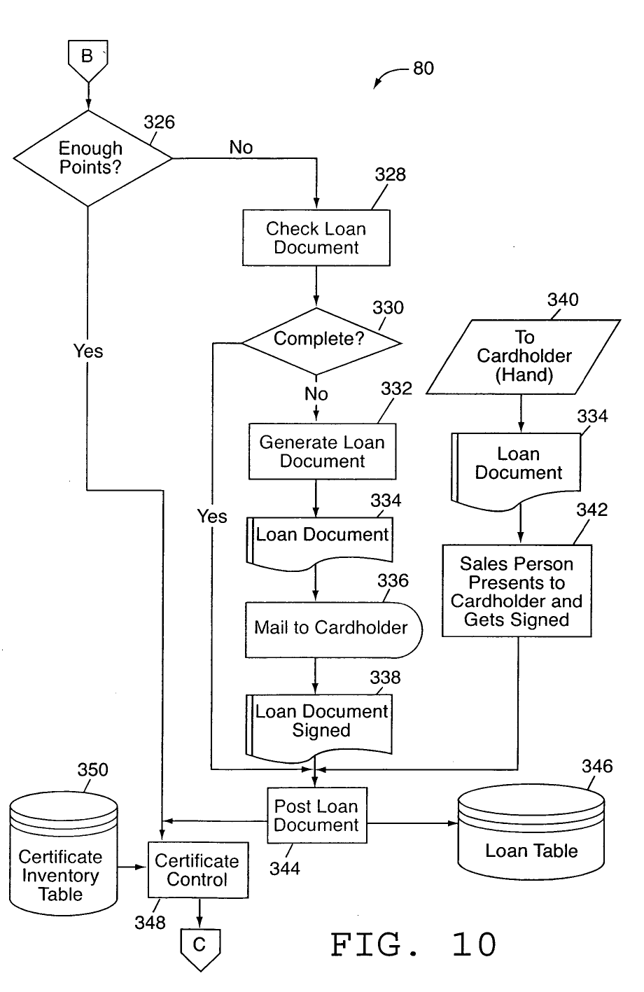

Turning now to FIG. 10. After the number of points required to issue a reward certificate are determined, the system determines 326 whether the customer has enough points in the account to be issued a certificate. In accordance with the present invention, if the customer does not have enough points in his account he may be able to borrow enough points to be issued a reward certificate nevertheless. In order to borrow points the customer may be required to enter into an agreement in the form, for example, of a loan document, wherein the account holder agrees to accumulate enough points in the future to satisfy the loan or, upon failing to gain sufficient points, to pay for the value of the reward certificate. The system may check to determine if there is an existing loan document 328 in place with the customer and whether or not it is complete 330. If a loan document is not already in place or complete the system automatically generates 332 such a loan document 334, which is an up-front incentives commitment document. By such a document the customer agrees to engage in specified account activities in the future to earn enough points to cover the points loan, or, upon failing to earn enough points, to pay for all or a portion of the value of the reward certificate. The loan document may be mailed 336 to the customer account holder to be signed 338 and returned by the customer before the points can be loaned. Alternatively, the loan document 334 may be handed physically 340 to the account holder, e.g., by a salesperson or other representative, to get the customer's signature 342. The signed loan document is then entered 344 into the system for processing. Point loans are recorded and stored in a loan table database 346. If the customer account has sufficient available points, either with or without a loan, a reward certificate may be issued. A certificate control function 348 consults information in a certificate inventory table database 350 for available reward certificate information.

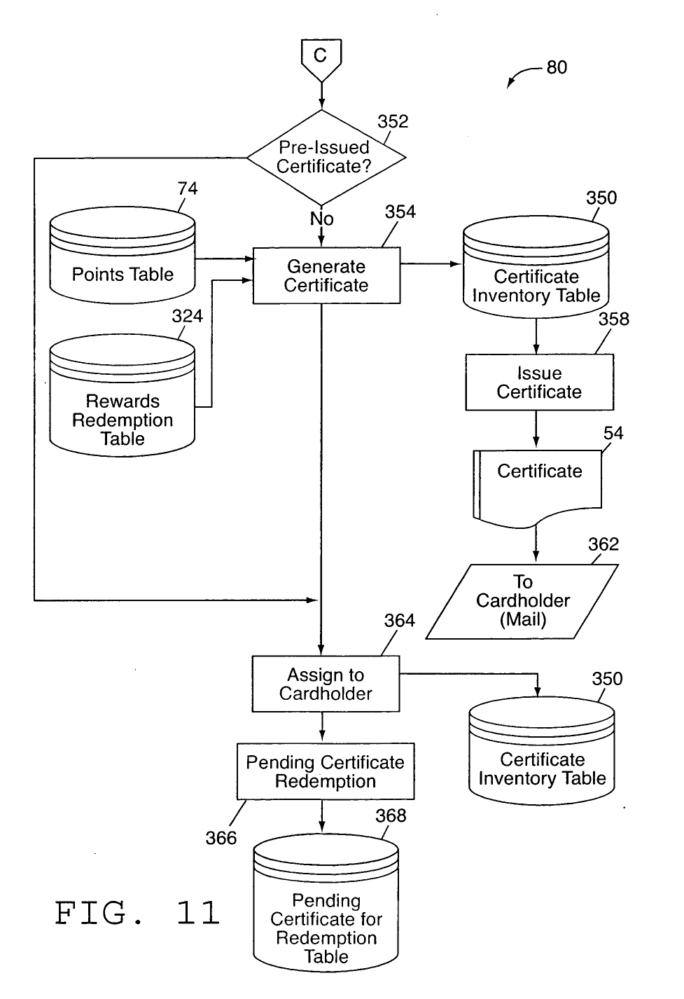

Turning now to FIG. 11. A determination 352 is made whether or not a reward certificate of the type requested has already been issued to the customer and needs only be assigned to the customer (e.g., activated) or whether a new reward certificate must be generated. If a pre-issued certificate does not exist, a rewards certificate may be generated 354 by the system using the points available information for the account from the points table database 74 and the points required for the certificate information from the rewards redemption table database 324. A certificate inventory table database 350, in which a record of each reward certificate issued is maintained, is updated in response to the issuance of a reward certificate. The reward certificate 54 may then be issued (printed) 358 and mailed 362 to the account holder in the manner described above. All issued certificates are assigned 364 to a customer account holder data record in the certificate inventory table database 350. At this point the issued reward certificate is assigned 366 a status of pending redemption. All reward certificates pending redemption may be recorded in a pending certificate for redemption table database 368.

An exemplary process for implementing the certificate redemption function 90 is illustrated in, and described in detail with reference to, the exemplary flow chart diagrams of FIGS. 12 and 13. Beginning with FIG. 12. A reward certificate 54 to be redeemed is presented to a merchant 400. For example, the reward certificate may be physically handed to the merchant or, in the case of an on-line merchant, submitted electronically. The merchant contacts 402 the financial account up-front incentives management system, e.g., by telephone or via an Internet or other connection to notify the system of the redemption request 404. The redemption request 404 is thus entered into the system and processed 406. The redemption request is validated 408 by checking the pending certificate redemption table database 368 to confirm that the certificate being attempted to be redeemed corresponds to a certificate pending redemption as recorded in the database 368. A customer account holder may not be allowed to redeem a reward certificate if his account is not in good standing. Thus, the system may also validate 410 that the customer's account is current by checking the customer account information stored in the cardholder file database 62.

Turning now to FIG. 13. If the reward certificate being redeemed is valid and the customer account is in good standing the redemption of the reward certificate by the customer is authorized 412. The merchant 416 may be notified 414, e.g., via telephone, the Internet, etc., that redemption of the reward certificate has been authorized so that the merchant 416 may, in turn, allow the customer to redeem the reward certificate for goods or services. The merchant can thus be confident that he will be paid by the certificate issuer for the goods or services provided to the customer. Once a reward certificate is redeemed, the certificate is closed 418 and the pending certificate redemption table database 368 is updated to indicate this change in status (from pending to redeemed). Information regarding the customer's point totals in the points table database 74 may be updated 420 to indicate that the points required to issue the reward certificate have been used.

An exemplary process for implementing the statement processing function 100 is illustrated in, and will be described with reference to, FIGS. 14 and 15. Beginning with FIG. 14. Points activity for the customer account, e.g., additions to and subtractions from the account point totals since the last customer account statement was produced, are reviewed and processed 500 based on the customer account information in the cardholder file database 62 and the account point information in the points table database 74. Reward certificate activity, e.g., reward certificates issued and/or redeemed since the last customer account statement was produced, are reviewed and processed 502 based on the issued certificate information in the certificate inventory table database 350 and the pending/redeemed certificate information in the pending certificate redemption table database 368. Point loan activity by the customer account holder, e.g., the borrowing of points by the customer against promised future account activity since the last customer statement was produced, are reviewed and processed 504 based on the point loan information in the loan table database 346. Based on the reviews of point activity 500, certificate activity 502, and loan activity 504 for the account a current point and loan balance and net customer commitment position is calculated 506.

Turning now to FIG. 15. The system may determine 508 whether or not a fee is due to be charged to the customer account. For example, a fee may be charged to the customer account if the customer borrowed points or otherwise obtained an up-front incentive based on a commitment to engage in agreed upon account activities, and then failed to satisfy his commitment. If such a fee is due, the penalty to be charged to the account (or to another account of the customer) may be computed 510 based, for example, on the value of the up-front incentive provided to the customer. The calculated fee may then be posted to the customer account to be charged in a conventional manner, e.g., as a charge transaction 512 to the customer account that is forwarded to the financial institution maintaining the charged account for processing. The charge transaction may be stored in a transaction file database 514. Customer statements 102 may then be generated by the system based on the information reviewed and processed. Thus, the statements 102 may provide to the customer the current status of the account with respect to points activity in the latest reporting period, reward certificate activity in the latest reporting period, point loan (up-front incentives) activity in the reporting period, current point and loan balances including a net point position, and an indication of any fees or penalties charged for failure on the part of the customer to satisfy an up-front incentives commitment. The statements 102 may be printed and forwarded 518 to the customer account holder via mail or, with the customer's permission, provided to the customer electronically, e.g., via the Internet.

Although exemplary embodiments of the present invention have been shown and described with reference to particular exemplary applications thereof, it will be apparent to those having ordinary skill in the art that a number of changes, modifications, or alterations to the invention as described herein may be made, none of which depart from the spirit or scope of the present invention. All such changes, modifications, and alterations should, therefore, be seen as being within the scope of the present invention.

1. A computer implemented system for managing incentives to holders of financial accounts to engage in specified account activities, comprising:
(a) a first database identifying customer accounts for which customer account holders have entered into agreements to engage in specified account activities related to the customer accounts in exchange for incentives that have been provided to the customers before the customers have engaged in the specified activities related to the accounts;
(b) an account activity database identifying account activity for the customer accounts; and
(c) a computer processor coupled to the first database and to the account activity database and programmed to monitor the account activity database for customer accounts identified in the first database to determine whether customers have satisfied their agreements to engage in specified account activities and to generate a customer charge for at least a portion of the value of the incentive provided for those customer accounts identified in the first database for which it is determined that the customers have not satisfied their agreements.

2. The system of claim 1 wherein the accounts identified in the first database are credit card accounts.

3. The system of claim 1 wherein the customer charges are to the customer accounts identified in the first database.

4. The system of claim 1 wherein the customer charges are to customer accounts other than the customer accounts identified in the first database.

5. A method for incentivizing holders of financial accounts to engage in specified account activities, comprising:
(a) offering to a customer account holder an incentive in exchange for a commitment to engage in specified activities related to the financial account;
(b) providing the incentive to the customer in response to the customer accepting the commitment and before the customer has engaged in the specified activities related to the account;
(c) monitoring customer financial account activity to determine whether the customer has satisfied the commitment to engage in specified activities related to the financial account; and
(d) charging a fee to the customer for at least a portion of the value of the incentive if the customer does not satisfy the commitment to engage in specified activities related to the account.

6. The method of claim 5 wherein the account is a credit card account.

7. The method of claim 5 wherein the incentive includes a merchandise reward.

8. The method of claim 5 wherein the incentive includes a reward certificate redeemable for a merchandise reward.

9. The method of claim 5 wherein the specified activities related to the account include at least one account activity selected from the group of account activities consisting of: opening the financial account and maintaining a minimum balance in the financial account for at least a selected period of time.

10. The method of claim 5 wherein charging a fee to the customer includes charging a fee to the financial account.

11. The method of claim 5 wherein charging a fee to the customer includes charging a fee to another financial account of the customer.

12. A method for incentivizing holders of financial accounts to engage in specified account activities, comprising:
(a) offering to a customer account holder an incentive in exchange for a commitment to engage in specified activities related to the financial account with a specified penalty if the customer fails to engage in the specified activities related to the financial account;
(b) providing the incentive to the customer in response to the customer accepting the commitment and before the customer engages in the specified activities related to the financial account;
(c) monitoring customer financial account activity to determine whether the customer has satisfied the commitment to engage in specified activities related to the financial account; and
(d) penalizing the customer with the specified penalty if the customer does not satisfy the commitment to engage in specified activities related to the financial account.

13. The method of claim 12 wherein the account is a credit card account.

14. The method of claim 12 wherein the incentive includes a merchandise reward.

15. The method of claim 12 wherein the incentive includes a reward certificate redeemable for a merchandise reward.

16. The method of claim 12 wherein the specified activities related to the account include at least one account activity selected from the group of account activities consisting of: opening the financial account and maintaining a minimum balance in the financial account for at least a selected period of time.

17. The method of claim 12 wherein the specified penalty includes a fee charged to the customer.

18. The method of claim 12 comprising additionally awarding reward points redeemable for rewards to the customer for engaging in selected account activities after the customer has engaged in the selected account activities and wherein the specified penalty includes a reduction in the reward points awarded to the customer.

19. The method of claim 12 comprising additionally awarding reward points redeemable for rewards to the customer for engaging in selected account activities and wherein the incentive includes reward points.

20. The method of claim 19 wherein the specified activities related to the financial account and the selected account activities include the same financial account activities.
